(19) United States
(12) Patent Application Publication
(10) Pub. No.: US 2013/0224338 A1
(43) Pub. Date: Aug. 29, 2013

(54) LIGHT MILK

(71) Applicants: Emily Marie Darchuk, Broomfield, CO (US); Stephen A. McCready, Arvada, CO (US)

(72) Inventors: Emily Marie Darchuk, Broomfield, CO (US); Stephen A. McCready, Arvada, CO (US)

(73) Assignee: WhiteWave Services, Inc., Dallas, TX (US)

(21) Appl. No.: 13/404,938

(22) Filed: Feb. 24, 2012

(51) Int. Cl. A23C 9/156; A23C 9/18; A23C 3/02; A23C 19/00; A23C 9/158; A23C 21/00; A23C 9/154

(52) U.S. Cl. 426/73; 426/580; 426/584; 426/583; 426/588; 426/573; 426/582; 426/442; 426/399

(57) ABSTRACT

In one embodiment, a mixture includes a dairy ingredient, a diluting ingredient having fewer calories per gram than the dairy ingredient, and one or more accentuating ingredients selected to accentuate a property of the dairy ingredient.

### TECHNICAL FIELD OF THE DISCLOSURE

This invention relates in general to dairy milk and, more particularly, to a light milk.

### BACKGROUND

Consuming dairy milk provides a multitude of health benefits. Milk may provide calcium, protein, and additional nutrients. Examples of milks available to consumers include skim milk, 1% milk, 2% milk, and whole milk. Skim milk may be relatively low in calories compared to milks with higher fat content. For example, skim milk typically includes approximately 80-90 calories per eight ounce serving. Certain consumers, however, may prefer milk with fewer calories than skim milk. Unfortunately, conventional low calorie milks may have a watered-down flavor and mouthfeel that consumers do not enjoy.

### SUMMARY

In one embodiment, a mixture includes a dairy ingredient, a diluting ingredient having fewer calories per gram than the dairy ingredient, and one or more accentuating ingredients selected to accentuate a property of the dairy ingredient.

Certain embodiments of the present disclosure may provide one or more technical advantages. As an example, in some embodiments, a light milk product may have fewer calories than skim milk. As another example, in some embodiments, the light milk product may have a flavor profile, a mouthfeel, a visual appearance (e.g., color or opacity), and/or a nutritional profile similar to skim milk.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example of a system for making a light milk product; and

FIG. 2 illustrates an example of a method for making a light milk product.

### DETAILED DESCRIPTION

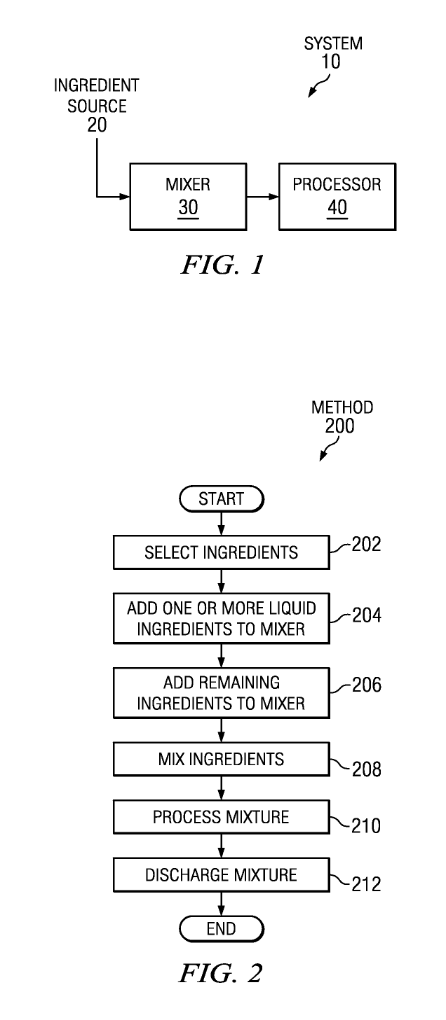

Embodiments of the present invention and its advantages are best understood by referring to FIGS. 1 to 2 of the drawings, like numerals being used for like and corresponding parts of the various drawings.

Consuming dairy milk provides a multitude of health benefits. Milk may provide calcium, protein, and additional nutrients. Examples of milks available to consumers include skim milk, 1% milk, 2% milk, and whole milk. Skim milk may be relatively low in calories compared to milks with higher fat content. For example, skim milk typically includes approximately 80-90 calories per eight ounce serving. Certain consumers, however, may prefer milk with fewer calories than skim milk. Unfortunately, conventional low calorie milks may have a watered-down flavor and mouthfeel that consumers do not enjoy. Embodiments of the present disclosure may provide a solution to these and other problems associated with conventional low calorie milks.

FIG. 1 illustrates an example of a system 10 for producing a reduced-calorie, dairy-based mixture that may be consumed as a beverage (e.g., light milk) or used as an ingredient in a food product, such as a flavored milk beverage (e.g., chocolate, vanilla, or strawberry milk), a milk-blend beverage (e.g., a blend including coffee, tea, juice, and/or other suitable beverage), a dairy-based food (e.g., cultured dairy, cheeses, sour cream, cottage cheese, yogurt, pudding), or other food product. In some embodiments, the mixture may comprise between approximately 5 and 30 calories per 100 grams. This may yield approximately 10 to 70 calories per eight ounce serving of light milk, such as approximately 10 to 30 calories, 30 to 50 calories, or 50 to 70 calories per serving.

In some embodiments, system 10 can include one or more ingredient sources 20, a mixer 30, and a processor 40. Ingredient source 20 can introduce ingredients into mixer 30. The ingredients can represent constituent elements that are deposited, mixed, or combined to yield the fortified food product. In some embodiments, the ingredients can include one or more dairy ingredients, one or more diluting ingredients, and one or more accentuating ingredients.

The dairy ingredient may include skim milk, 1% milk, 2% milk, whole milk, lactose free milk, dairy proteins, nonfat dried milk (NFDM), milk powders, other dairy powders, and/or other suitable dairy ingredients or combinations of dairy ingredients. In certain embodiments, skim milk may be selected to provide milky properties without introducing as many calories as milks with higher fat content.

The diluting ingredient may be selected to dilute the mixture such that the mixture has a lower calorie content than a comparable amount of the dairy ingredient alone. Accordingly, the diluting ingredient may have fewer calories per gram than the dairy ingredient. As an example, the dairy ingredient may comprise skim milk and the diluting ingredient may comprise water. The skim milk may have approximately 80 calories per eight ounce serving, whereas the water may have zero calories per eight ounce serving. A mixture of skim milk and water would have an intermediate number of calories per eight ounce serving (less than 80 calories, but more than zero calories). The specific number of calories would depend on the ratio of skim milk to water. Increasing the amount of the diluting ingredient may yield a calorie reduction by reducing the parts per million (ppm) of fat, protein, and/or carbohydrate present in the mixture. For example, in certain embodiments, the amount of carbohydrate present in light milk may be in the range of approximately 5 to 10 grams, such as 7 to 9 grams of carbohydrates per eight ounce serving, as compared to approximately 13 grams per eight ounce serving of skim milk. In certain embodiments, the light milk may comprise less than 2% fat, such as less than 1% fat, for example, less than 0.5% fat.

The accentuating ingredient may be selected to accentuate a property of the

dairy ingredient, such as the milky flavor profile, the mouthfeel, the appearance, and/or the nutritional profile. For example, mixing the dairy ingredient (e.g., skim milk) with the diluting ingredient (e.g., water) may yield a light milk with a watery flavor, a watery mouthfeel, a translucent appearance, and fewer nutrients than a comparable amount of skim milk alone. The accentuating ingredient may be selected to accentuate the flavor, mouthfeel, appearance, and/or nutritional profile of the diluted skim milk so that the sensory properties of the light milk mixture resemble those of skim milk. In addition, certain accentuating ingredients may function as protein stabilizers, buffers, or dispersants. The type and amount of the accentuating ingredient may be selected to maintain a relatively low calorie content in the final mixture, such as between 5 and 30 calories per 100 grams of the mixture. This may yield approximately 10 to 70 calories per eight ounce serving of light milk.

Examples of the accentuating ingredient include proteins, sweeteners, colorants, stabilizers, flavorings, health supplements, buffering agents, salts, bulking agents (e.g., maltodextrin, dextrose, and so on), and/or any other suitable ingredient.

Examples of proteins include whey or other dairy based powders.

Examples of sweeteners include natural sweeteners, artificial sweeteners, or a combination. Examples of natural sweeteners include sucrose, fructose, corn syrup, sugar, liquid sugar, crystallized sugar, honey, agave, cane juice, natural high intensity sweeteners (e.g., luo han guo and its derivatives, stevia and its derivatives, such as steviol glycosides, rebiana-A, and rebaudioside-A), and so on. Examples of artificial sweeteners include sucralose, aspartame, and saccharine. Sweeteners can be added to enhance the taste of the flavorings provided and/or provide overall sweetness to the product.

Examples of colorants include titanium dioxide, Federal Food, Drug, and Cosmetic Act (FD&C) colors, natural colors, lakes, and so on. Colorants can be added to enhance the visual properties of the mixture.

Examples of stabilizers can include, but are not limited to, thickeners, emulsifiers (e.g., mono and diglycerides, polyoxyethylene derivatives of sorbitan esters, and so on), starches (e.g., modified food starch, native food starch, etc.), buffering agents (e.g., buffering salts), and various gums and/or hydrocolloids such as guar, acacia, locust bean, xanthan, gellan, carrageenan, cellulose, and pectin. Stabilizers can enhance physical properties of beverages by imparting viscosity or mouthfeel properties that can increase consumer appeal. Stabilizers can be natural or artificial and can contribute to a uniform appearance of products by stabilizing and/or suspending insoluble materials, stabilizing and/or suspending protein, and preventing separation or settling of ingredients.

Examples of flavorings include cream flavoring, dairy/milk flavoring, vanilla extract, almond extract, citrus extract, cocoa powder, strawberry or other fruit flavoring, or any other appropriate extracts, chemical compounds, or natural additives suitable to alter the taste of the mixture. Flavorings may be added to enhance the taste properties of the mixture.

Examples of health supplements include vitamins (e.g., vitamin A, B vitamins, vitamin C, vitamin D, vitamin E, etc.), minerals (e.g., calcium, potassium, iron), herbs (e.g., chamomile, lavender, lemon balm), probiotics (e.g., yogurt cultures), and functional ingredients (e.g., omega-3 fatty acids, conjugated linoleic acid, protein, amino acids, fiber, plant sterols, etc.). Health supplements can enhance the nutritional profile of the food product or provide health benefits. In certain embodiments, the health supplements may be selected to provide at least the vitamins and minerals of skim milk, for example, the health supplements may include vitamin A, vitamin D, and calcium.

Examples of buffering agents include sodium citrate, disodium phosphate, calcium citrate, potassium citrate, potassium phosphate, dipotassium phosphate, derivatives of the preceding, and so on. Buffering agents may keep the protein of the food product in suspension and/or enhance protein stability of the food product.

In some embodiments, certain salts may be selected primarily to impart taste to the product. Examples may include sea salt and/or sodium chloride. Certain salts may be selected primarily to act as buffering agents. Examples may include sodium citrate, disodium phosphate, calcium citrate, sodium chloride, potassium citrate, potassium phosphate, and/or dipotassium phosphate.

Although ingredients in the preceding examples have been used to illustrate certain properties, certain ingredients may be characterized by more than one property. As an example, dipotassium phosphate may provide stabilization to the product and may fortify the product with potassium and phosphorous.

Light milk may include any suitable combination of ingredients. In one embodiment, for example, the dairy ingredient includes skim milk as a source of protein and dairy flavor, the diluting ingredient includes filtered water to reduce the overall calories in the product, and the accentuating ingredients include milk protein isolate and/or whole milk powder, nutritive sweeteners and bulking agents (fructose, sucrose, and/or maltodextrin), flavors, such as dairy based powder and/or other characterizing flavors of dairy, stabilizers (carrageenan and gellan gum), buffering agents (e.g., buffering salts), and whitener. The milk protein isolate and whole milk powder provide protein and impart dairy flavor, color, and mouthfeel. The nutritive sweeteners and bulking agents provide sweetness and enhance appearance and mouthfeel. The stabilizers provide mouthfeel similar to skim milk and suspension of solids. The buffering agents protect the protein and the product stability during processing. The light milk may include additional ingredients to enhance appearance, flavor, and/or nutritional profile. Such ingredients may include salt, colorants, dietary fiber, and added vitamins and minerals (vitamin A, vitamin D, calcium).

In operation, an operator of system 10 selects appropriate ingredients for the desired finished product. Once appropriate ingredients are selected, the operator introduces the selected ingredients into mixer 30. Ingredients can be added serially (i.e., one at time), collectively (i.e., all ingredients are added substantially at once), or a combination (i.e., certain subsets of ingredients are pre-combined, and the combination is added serially with other ingredients or ingredient combinations). Ingredients can be added in any suitable form, such as a liquid form or a dry-blend.

In some embodiments, mixer 30 can combine the dairy ingredient, the diluting ingredient, the accentuating ingredient, and other ingredients to produce a mixture, such as a light milk. Mixer 30 can comprise any appropriate container suitable to receive, mix, and/or discharge one or more ingredients. In particular embodiments, mixer 30 can comprise a stainless steel chamber of any suitable size. For example, mixer 30 can be sized to mix the mixture of ingredients in large batches that can later be divided into smaller sizes suitable for sales to consumers, or mixer 30 can be sized to mix smaller, individual-sized portions.

Mixer 30 can receive the ingredients through one or more different inlets. For example, the ingredients can be added to the mixing chamber through one or more nozzles, hose inlets, or openings in mixer 30. Mixer 30 can include one or more means for blending, mixing, combining, stirring, and/or agitating ingredients. For example, mixer 30 can include mechanical agitators, pressure jets, or other suitable mixing devices, whether located within mixer 30 or external to mixer 30. Alternatively, mixer 30 can allow for stirring or mixing by hand. In some embodiments, mixer 30 can be chilled (depending on the particular ingredients used) to prevent one or more ingredients from spoiling during mixing and/or processing. Accordingly, mixer 30 can include a jacketed or insulated tank to maintain appropriate temperatures. Mixer 30 can also include one or more discharge outlets connected to other components of system 10. For example, mixer 30 can include one or more discharge outlets connected to hoses or tubes, which can carry an aqueous solution mixed by mixer 30 to processor 40, which can comprise one or more processing components.

After an appropriate mixing time, the mixture can be discharged into processor 40 manually or through one or more nozzles, hoses, spigots, piping, or other appropriate discharging outlet. Processor 40 can comprise one or more components for further processing the mixture. As an example, processor 40 can include means for pasteurizing the mixture to reduce the number of undesirable microorganisms and prolong shelf life. As another example, processor 40 can include a homogenizer or other means for reducing particle size so that particle distribution can be maintained and mouthfeel can be improved. Processor 40 can comprise any other components for producing a finished food product. In some embodiments, the finished food product can comprise a light milk having approximately 10 to 70 calories per eight ounce serving. Alternatively, the finished food product may comprise another dairy-based, reduced-calorie food product, such as a flavored milk beverage (e.g., chocolate, vanilla, or strawberry milk), a milk-blend beverage (e.g., a blend including coffee, tea, juice, and/or other suitable beverage), cultured dairy, cheeses, sour cream, cottage cheese, yogurt, or other food product.

In some embodiments, the finished food product can be directed from processor 40 to storage or to packaging, bottling, or filling components suitable to ready the finished food product for commercial sale or use. For example, packaging components can deposit an amount of the mixture into one or more bottles, jars, cans, cartons, and/or any other appropriate container.

Modifications, additions, or omissions can be made to system 10 without departing from the scope of the invention. The components of system 10 can be integrated or separated. Moreover, the operations of system 10 can be performed by more, fewer, or other components.

FIG. 2 is a flow diagram illustrating a method 200 for producing a light milk product. The method begins at step 202 where appropriate ingredients are selected. Ingredients may include a dairy ingredient, a diluting ingredient, and one or more accentuating ingredients. Table 1 illustrates an example of ingredients that may be selected for a light milk formulation. Ingredients may be measured by weight.

TABLE 1

| Ingredient | Approximate Range | Example Range |
|---|---|---|
| Filtered Water | 5-90% | 50-80% |
| Skim Milk | 0-75% | 10-50% |
| Carrageenan | 0-5% | 0.01-2% |
| Gellan Gum | 0-5% | 0.01-0.5% |
| Stabilizing Salts | 0-5% | 0.01-1.0% |
| Whole Milk Powder | 0-30% | 0.01-5.0% |
| Maltodextrin | 0-20% | 0.1-10% |
| Fructose | 0-10% | 0.01-2.0% |
| Sodium Chloride | 0-5% | 0.01-2.0% |
| Flavoring | 0-2% | 0.01-1.0% |
| Vitamins A and D | 0-2% | 0.0001-1.0% |
| Calcium Carbonate | 0-2% | 0.01-1.0% |
| Titanium Dioxide | 0-2% | 0.01-1.0% |

In the example of Table 1, the dairy ingredient comprises skim milk and the diluting ingredient comprises filtered water. The accentuating ingredients include carrageenan (e.g., kappa, iota, and/or lambda carrageenan), gellan gum, stabilizing salts, whole milk powder, maltodextrin, fructose, sea salt, flavor, vitamin A, vitamin D, calcium, and/or titanium dioxide. In certain embodiments, the accentuating ingredients may be used as stabilizers, flavor accentuators, nutrient accentuators, and/or appearance accentuators. The stabilizers, such as the hydrocolloids (carrageenan and gellan gum), buffering agents, salts, and bulking agent (maltodextrin), may generally impart stability, texture, viscosity, and/or mouthfeel to the light milk. For example, certain stabilizers may provide suspension of solids, minimize fat separation, provide stability for withstanding thermal processing, and/or provide stability for withstanding a pH change (e.g., reduces feathering when the light milk is added to coffee/tea). The flavor accentuators may impart creaminess, sweetness, or other flavor profile of milk. For example, whole milk powder and/or cream flavoring may accentuate the creaminess and fructose and/or maltodextrin, may accentuate the sweetness characteristic associated with milk. The salts may round out the flavor profile. The nutrient accentuators may include vitamin A, vitamin D, and calcium carbonate (a calcium source). Finally, titanium dioxide and maltodextrin may contribute to a milk-like appearance by imparting opacity and/or whitening.

At step 204, one or more liquid ingredients may be introduced into a mixer. For example, in certain embodiments, the diluting ingredient (e.g., water) and/or the dairy ingredient (e.g., a milk) may be introduced into the mixer.

The remaining ingredients may be introduced into the mixer at step 206. Ingredients can be added serially (i.e., one at time), collectively (i.e., all ingredients are added substantially at once), or a combination (i.e., certain subsets of ingredients are pre-combined, and the combination is added serially with other ingredients or ingredient combinations). Ingredients can be added in any suitable form, such as a liquid form or a dry-blend.

At step 208, the ingredients may be mixed or combined in any appropriate manner to facilitate the dispersing the ingredients substantially evenly throughout and dissolution of the dry ingredients, if any, in the mixture. For example, mechanical agitators, pressure jets, or other suitable mixing devices may be used to stir, mix, blend, agitate, or otherwise combine the ingredients. As another example, the ingredients may be stirred or mixed by hand. As another example, a motionless mixer may be used to mix the ingredients. Mixing may continue until the ingredients are distributed substantially evenly throughout the product.

The method proceeds to step 210 for further processing. In some embodiments, the mixture can be discharged from the mixing chamber and directed to processing components operable to perform pasteurization, high pressure pasteurization, filtration, sonication, homogenization, high pressure homogenization, and/or other suitable processing. In certain embodiments, a light milk product can be pasteurized by heating the product (e.g., using direct steam injection or indirect heating) and holding it at a selected temperature (e.g., between approximately 160 and 325° F.) for a pre-determined amount of time. The temperature and holding time can be selected according to a High Temperature/Short Time (HTST), Extended Shelf Life (ESL), Ultra High Temperature (UHT), or other suitable techniques. In certain embodiments, the accentuating ingredients may be selected so the product can withstand the high temperatures of UHT processing and ESL filling in order to yield a shelf life greater than 60 days (compared to the less than 21 day shelf life of a gallon of conventional skim milk produced by HTST pasteurization).

As another example, the light milk can be homogenized. Any suitable homogenization technique can be used, such as directing the mixture through an orifice at a high pressure (e.g., up to approximately 20,000 pounds per square inch (psi)) to shear the component particles and produce smaller sized particles. As an example, homogenization can use a pressure in the range of approximately 1000-3000 psi. A second stage of homogenization can optionally be applied, for example, using a pressure in the range of approximately 500-1000 psi. In some alternate embodiments, high pressure homogenization can be applied. High pressure homogenization can use a pressure greater than 10,000 psi, such as approximately 20,000 psi.

At step 212, the mixture can be discharged from the system. The finished product can be packaged and stored in refrigerated or unrefrigerated storage. The method then ends.

The steps illustrated in FIG. 2 can be combined, modified, or deleted where appropriate, and additional steps can also be added to those shown. Additionally, the steps can be performed in any suitable order without departing from the scope of the present disclosure. For example, some or all of the ingredients can be added collectively at a similar time or alternatively ingredients can be added serially at different times. In certain embodiments, a liquid dairy ingredient (e.g., skim milk) and the diluting ingredient (e.g., water) may be added first, followed by a first dry blend, followed by a protein source, and then a second dry blend, and finally any remaining ingredients. The first dry blend may include stabilizing ingredients, such as buffering agents, salts, and gums. The stabilizing ingredients may stabilize the protein and other components of the mixture. The protein source may comprise whey, powdered milk, or other protein source. The second dry blend may include flavorings, bulking agents, vitamins and minerals, and sweeteners. The remaining ingredients may include other liquid ingredients, such as liquid flavoring, colorants, or any other ingredients.

The systems and methods described can include one or more technical advantages. A technical advantage of certain embodiments may be that a light milk product has fewer calories than skim milk. In certain embodiments, the light milk may comprise at least 10% fewer calories than skim milk, such as 10-30%, 30-50%, 50-70%, or 70-90% fewer calories than skim milk. To illustrate, if an eight ounce serving of skim milk has approximately 80 calories, a light milk with 30% fewer calories would have about 55 calories per eight ounce serving. A technical advantage of certain embodiments may be that a light milk has a flavor profile, a mouthfeel, a visual appearance (e.g., color or opacity), and/or a nutritional profile similar to milk (e.g., skim milk).

Although the present disclosure has been described with several embodiments, numerous changes, variations, alterations, transformations, and modifications can be suggested to one skilled in the art, and it is intended that the present disclosure encompass such changes, variations, alterations, transformations, and modifications as fall within the scope of the appended claims.

1. A mixture, comprising:
skim milk present in an amount between approximately 10-50% of the mixture;
a diluting ingredient, the diluting ingredient comprising water present in an amount between approximately 50-80% of the mixture; and
one or more accentuating ingredients that accentuates a property of the dairy ingredient, the one or more accentuating ingredients comprising:
whole milk powder present in an amount less than approximately 5% of the mixture; and
maltodextrin present in an amount less than approximately 10% of the mixture.

2. The mixture of claim 1, wherein the mixture comprises fewer than approximately 30 calories per 100 grams.

3. The mixture of claim 1, wherein the accentuating ingredients include one or more stabilizers.

4. The mixture of claim 1, wherein the accentuating ingredients include one or more health supplements.

5. The mixture of claim 1, wherein the accentuating ingredients include one or more ingredients selected to impart a flavor profile associated with milk.

6. The mixture of claim 1, the one or more accentuating ingredients further comprising:
carrageenan present in an amount less than approximately 2% of the mixture;
gellan gum present in an amount less than approximately 0.5% of the mixture;
one or more stabilizing salts present in an amount less than approximately 1% of the mixture;
one or more stabilizing salts present in an amount less than approximately 1% of the mixture, wherein at least one of the stabilizing salts comprise a citrate salt or a phospate salt; and
fructose present in an amount less than approximately 2% of the mixture.

7. The mixture of claim 6, the one or more accentuating ingredients further comprising:
sodium chloride present in an amount less than approximately 2% of the mixture;
cream flavoring present in an amount less than approximately 1% of the mixture;
vitamin A present in an amount leas than approximately 1% of the mixture;
vitamin D present in an amount less than approximately 1% of the mixture;
calcium carbonate present in an amount less than approximately 1% of the mixture; and
titanium dioxide present in an amount less than approximately 1% of the mixture.

8. The mixture of claim 1, wherein the mixture comprises less than approximately 1% fat.

9. The mixture of claim 1, wherein the mixture forms a component of a food product selected from the group consisting of: flavored milk beverages, milk-blend beverages, puddings, cultured dairy, cheeses, sour creams, cottage cheeses, and yogurts.

10. A light milk mixture, comprising:
a dairy ingredient comprising skim milk present its an amount between approximately 10-50% of the mixture;
a diluting ingredient comprising water present in an amount between approximately 50-80% of the mixture; and
a plurality of accentuating ingredients, wherein one or more of the accentuating ingredients impart a flavor and mouthfeel similar to skim milk and one of the accentuating ingredients comprises whole milk powder present in an amount less than approximately 1% of the mixture;
the mixture comprising at least 10% fewer calories per gram than skim milk.

11. The mixture of claim 10, wherein the accentuating ingredients include vitamin A, vitamin D, and a calcium source selected to impart a nutritional profile similar to skim milk.

12. The mixture of claim 10, wherein the accentuating ingredients include one or more ingredients selected to impart an opacity and color similar to skim milk.

13. The mixture of claim 10, wherein the one or more of accentuating ingredients includes a buffering agent or salt selected or derived from the group consisting of sodium citrate, sodium chloride, sea salt, disodium phosphate, potassium citrate, and calcium citrate.

14. The mixture of claim 10, wherein the one or more accentuating ingredients includes a stabilizer selected from the group stabilizers consisting of carrageenan, guar gum, locust bean gum, modified food starch, gellan gum, native food starch, and xanthan gum.

15. The mixture of claim 10, wherein the one or more accentuating ingredients includes an emulsifier selected form the group of eniuisifiers consisting of monoglycerides, diglycerides, and polyoxyethylene derivatives of sorbitan esters.

16. The mixture of claim 10, wherein the accentuating ingredients include:
carrageenan present in an amount less than approximately 2% of the mixture, the carrageenan comprising kappa carrageenan, iota carrageenan, lambda carrageenan, or a combination;
one or more sweeteners present in an amount less than approximately 2% of the mixture, the sweeteners including fructose, sucrose, corn syrup, cane juice, stevia, derivatives of stevia, or a combination; and
one or more salts, the salts present in an amount less than approximately 3% of the mixture.

17. The mixture of claim 16, wherein the accentuating ingredients further include:
flavoring;
gellan gum present in an amount less than approximately 0.5% of the mixture; and
one or more bulking agents present in an amount less than approximately 10% of the mixture, the bulking agents including maltodextrin, dextrose, or a combination.

18. The mixture of claim 10, wherein one of the accentuating ingredients comprises a natural high intensity sweetener and the mixture includes less than approximately 40 calories per eight ounce serving.

19. A method comprising:
introducing a dairy ingredient into a mixing chamber;
introducing a diluting ingredient into the mixing chamber, the diluting ingredient having fewer calories per gram than the dairy ingredient;
introducing one or more accentuating ingredients into the mixing chamber, the one or more accentuating ingredients selected to accentuate a property of the dairy ingredient;
mixing the dairy ingredient, the diluting ingredient, and the one or more accentuating ingredients in order to yield a mixture;
discharging the mixture from the mixing chamber.

20. The method of claim 19, further comprising:
pasteurizing the mixture using ultra high temperature pasteurization; and
packaging the mixture using extended shelf life filling.

21. The method of claim 19, wherein:
the dairy ingredient comprises skim milk;
the diluting ingredient comprises water;
the accentuating ingredients include:
a first dry blend comprising one or more of a buffering agent or a gum;
a protein source;
a second dry blend comprising one or more of a bulking agent, a sweetener, a flavoring, a vitamin, or a mineral; and
the ingredients are introduced to the mixing chamber according to a sequence of a) the skim milk and water, b) the first dry blend, c) the protein source, d) the second dry blend; and
further comprising homogenizing the mixture.
